(19) United States
(12) Patent Application Publication
(10) Pub. No.: US 2020/0263392 A1
(43) Pub. Date: Aug. 20, 2020

(54) VIBRATION SUPPRESSION CONTROL CIRCUIT

(71) Applicant: KAWASAKI JUKOGYO KABUSHIKI KAISHA, Kobe-shi, Hyogo (JP)

(72) Inventors: Makoto ITO, Kobe-shi (JP); Syunichi SAKAMOTO, Kakogawa-shi (JP); Takahiro OKAZAKI, Kobe-shi (JP)

(73) Assignee: KAWASAKI JUKOGYO KABUSHIKI KAISHA, Kobe-shi, Hyogo (JP)

(21) Appl. No.: 16/608,928

(22) PCT Filed: Apr. 27, 2018
(86) PCT No.: PCT/JP2018/017248

§ 371 Date: Oct. 28, 2019

(30) Foreign Application Priority Data
Apr. 27, 2017 (JP) 2017-087842

(51) Int. Cl. E02F 9/22; F15B 11/02

(52) U.S. Cl. CPC E02F 9/2221; F15B 11/02; E02F 9/2267; E02F 9/2217

(57) ABSTRACT

In a vibration suppression control OFF state, a signal pressure supply control valve stops supplying a first signal pressure, a pressure-regulating valve is in first position where a supply/discharge port connects to a pump port, and an open/close signal pressure is not supplied to an open/close control valve, so an open/close valve is closed. When the OFF state switches to ON state, the signal pressure supply control valve allows supplying the first signal pressure, and the pressure-regulating valve is in second position where the supply/discharge port connects to a tank port, so the pressure of a pressure accumulator decreases. In the ON state, when the pressure of the pressure accumulator is equal to pressure of a pressure chamber, the pressure-regulating valve is in third position where the supply/discharge port is blocked, and the open/close signal pressure is supplied to the open/close control valve, so the open/close valve is opened.

### TECHNICAL FIELD

The present invention relates to a vibration suppression control circuit installed in a work vehicle, such a wheel loader.

### BACKGROUND ART

While a work vehicle is running, if a work apparatus of the work vehicle vibrates, it also causes vibration to the vehicle body and the operator's seat. In light of this problem, some of the work vehicles are equipped with a running vibration suppressing device. While such a work vehicle equipped with the running vibration suppressing device is running, the running vibration suppressing device allows the pressure chamber of an actuator that moves the work apparatus to communicate with a pressure accumulator (see Patent Literature 1, for example). As a result of the pressure chamber communicating with the pressure accumulator, pressure pulsation of the pressure chamber can be absorbed by the pressure accumulator. In this manner, vibration of the work apparatus can be suppressed, and consequently, vibration of the vehicle body can be suppressed, thereby improving the comfortableness of the ride.

The running vibration suppressing device is provided with pressure sensors that detect the load pressure of the actuator and the pressure of the pressure accumulator. Based on the detected two pressures, a controller controls a ride control valve that controls whether or not to allow the communication between the pressure accumulator and the pressure chamber. If the pressure of the pressure accumulator is higher than the load pressure, the controller controls the ride control valve to: lower the pressure of the pressure accumulator to the load pressure; and then allow the pressure accumulator to communicate with the pressure chamber.

### CITATION LIST

### Patent Literature

PTL 1: Japanese Patent No. 4456078

### SUMMARY OF INVENTION

### Technical Problem

However, the above-described running vibration suppressing device requires a plurality of pressure sensors, and also requires construction and implementation of a control routine that is executed by referring to the pressures detected by the pressure sensors. For these reasons, both hardware and software configurations of the running vibration suppressing device are complex.

An object of the present invention is to provide a vibration suppression control circuit that is intended for a work vehicle and that can be simplified in configuration.

### Solution to Problem

A vibration suppression control circuit according to one aspect of the present invention is a vibration suppression control circuit installed in a work machine, the work machine including an actuator configured to move a work apparatus mounted to a vehicle body of the work machine in accordance with supply and discharge of pressure oil to and from a pressure chamber of the actuator, the vibration suppression control circuit being switchable between a vibration suppression control OFF state and a vibration suppression control ON state while the work machine is running. The vibration suppression control circuit includes: a pressure accumulator; a pressure-regulating valve including, a supply/discharge port connected to the pressure accumulator via a supply/discharge line, a pump port, a tank port, a first signal chamber to which a pressure of the pressure accumulator is led as a first signal pressure, and a second signal chamber to which a pressure of the pressure chamber is led as a second signal pressure; a signal pressure supply control valve configured to control whether or not to allow supplying the first signal pressure to the first signal chamber; an open/close valve provided on a branch line, the branch line being branched off from the supply/discharge line and connected to the pressure chamber; and an open/close control valve configured to control an opened/closed state of the open/close valve in accordance with presence or absence of supply of an open/close signal pressure to the open/close control valve. While the vibration suppression control circuit is in the vibration suppression control OFF state, the signal pressure supply control valve stops supplying the first signal pressure, the pressure-regulating valve is positioned in a first position in which the supply/discharge port is connected to the pump port, such that the pressure is accumulated in the pressure accumulator, and the open/close signal pressure is not supplied to the open/close control valve, such that the open/close valve is closed. When the vibration suppression control circuit switches from the vibration suppression control OFF state to the vibration suppression control ON state, the signal pressure supply control valve allows supplying the first signal pressure, and the pressure-regulating valve is brought into a second position in which the supply/discharge port is connected to the tank port, such that the pressure of the pressure accumulator decreases. While the vibration suppression control circuit is in the vibration suppression control ON state, when the pressure of the pressure accumulator has become equal to the pressure of the pressure chamber, the pressure-regulating valve is brought into a third position in which the supply/discharge port is blocked, and the open/close signal pressure is supplied to the open/close control valve, such that the open/close valve is opened.

According to the above configuration, while the vibration suppression control circuit is in the vibration suppression control OFF state, since the open/close valve is closed, the pressure accumulator is blocked from the pressure chamber. The pressure accumulator communicates with the pump port, and the pressure of the pressure accumulator increases. When the work machine starts running, the vibration suppression control circuit switches from the vibration suppression control OFF state to the vibration suppression control ON state. When the switching to the vibration suppression control ON state is made, first, the pressure of the pressure accumulator is led to the first signal chamber of the pressure-regulating valve. Immediately after the first signal pressure starts to be led to the first signal chamber, the pressure of the pressure accumulator (the first signal pressure) may be higher than the pressure of the pressure chamber (the second signal pressure). The pressure accumulator communicates with the tank port. Accordingly, the pressure of the pressure accumulator decreases. When the pressure of the pressure accumulator (the first signal pressure) has decreased to be equal to the pressure of the pressure chamber (the second signal pressure), the supply/discharge port connected to the pressure accumulator and the pressure chamber is blocked, and then the open/close valve is opened to bring the pressure accumulator into communication with the pressure chamber. Accordingly, pressure pulsation of the pressure chamber can be absorbed by the pressure accumulator. In this manner, vibration of the work apparatus can be suppressed, and consequently, vibration of the vehicle body can be suppressed.

After the switching to the vibration suppression control ON state is made, the open/close valve remains closed until the pressure of the pressure accumulator becomes equal to the pressure of the pressure chamber. In this manner, the pressure accumulator can be prevented from communicating with the pressure chamber when the pressure of the pressure accumulator is higher than the pressure of the pressure chamber. This makes it possible to prevent a shock to the vehicle body from occurring immediately after the switching to the vibration suppression control ON state is made. When the pressure of the pressure accumulator has decreased to be equal to the pressure of the pressure chamber, the open/close signal pressure is supplied to the open/close control valve to cause the open/close control valve to open the open/close valve. Therefore, promptly after the state in which the aforementioned shock will not occur (i.e., a state where there is no difference between the pressure of the pressure accumulator and the pressure of the pressure chamber) is realized, it becomes possible to suppress vibration of the work apparatus and vibration of the vehicle body.

The vibration suppression control circuit may include an open/close signal pressure supply valve including: a supply/discharge port connected to the open/close control valve; a first signal chamber to which the pressure of the pressure accumulator is led as a first signal pressure; and a second signal chamber to which the pressure of the pressure chamber is led as a second signal pressure. While the vibration suppression control circuit is in the vibration suppression control OFF state, the open/close signal pressure supply valve may be positioned in such a valve position that the supply/discharge port is connected to a drain. While the vibration suppression control circuit is in the vibration suppression control ON state, when the first signal pressure has become lower than or equal to the second signal pressure, the open/close signal pressure supply valve may be brought into such a valve position that the open/close signal pressure is supplied to the supply/discharge port.

The above configuration makes it possible to promptly and automatically bring, by means of hydraulic pressure, the pressure accumulator into communication with the pressure chamber when the pressure of the pressure accumulator has become equal to the pressure of the pressure chamber after the switching to the vibration suppression control ON state is made.

The pressure-regulating valve may be configured as an integrated valve that includes an open/close supply/discharge port connected to the open/close control valve. While the vibration suppression control circuit is in the vibration suppression control OFF state, the integrated valve may be positioned in the first position, such that the open/close supply/discharge port is connected to a drain. When the vibration suppression control circuit switches from the vibration suppression control OFF state to the vibration suppression control ON state, the integrated valve may be brought into the second position, such that the open/close supply/discharge port is connected to the drain. While the vibration suppression control circuit is in the vibration suppression control ON state, when the pressure of the pressure accumulator has become equal to the pressure of the pressure chamber, the integrated valve may be brought into the third position, such that the open/close signal pressure is supplied to the open/close supply/discharge port.

The above configuration allows the pressure-regulating valve to additionally have the function of automatically supplying the open/close signal pressure by means of hydraulic pressure. As a result, the signal pressure supply line is simplified, and thereby the configuration of the vibration suppression control circuit is made compact.

### Advantageous Effects of Invention

The present invention makes it possible to provide a vibration suppression control circuit that is intended for a work vehicle and that can be simplified in configuration.

### BRIEF DESCRIPTION OF DRAWINGS

FIG. 1 is a side view of a wheel loader illustrated as one example of a work vehicle in which a vibration suppression control circuit is installed.

FIG. 2 shows the configuration of the vibration suppression control circuit according to Embodiment 1.

FIG. 3 is a timing diagram illustrating the functions of the vibration suppression control circuit.

FIG. 4 shows the configuration of a vibration suppression control circuit according to Embodiment 2.

### DESCRIPTION OF EMBODIMENTS

Hereinafter, embodiments are described with reference to the drawings. In the drawings, the same or corresponding elements are denoted by the same reference signs, and repeating the same descriptions is avoided below. Directions mentioned in the description below are directions from the perspective of an operator of a work vehicle.

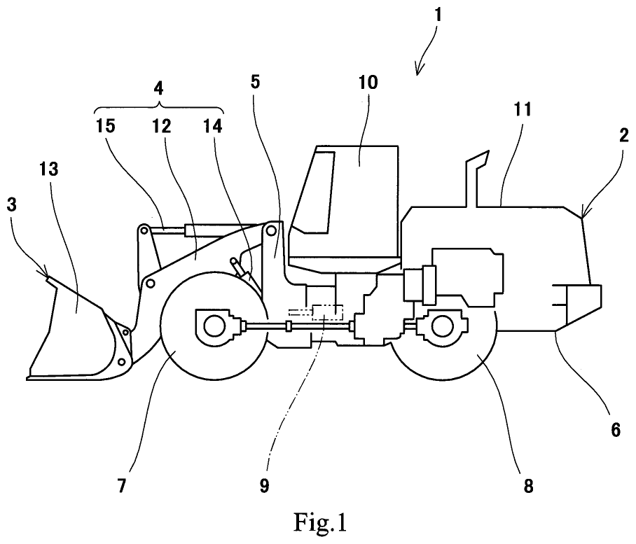

FIG. 1 shows a work vehicle 1. The work vehicle 1 is a wheel loader, which is one of the wheel-driven industrial vehicles. However, the present invention is also applicable to other work vehicles, such as a shovel loader, a forklift, and a truck crane. The work vehicle 1 includes a vehicle body 2, a work apparatus 3, and an actuator 4.

The vehicle body 2 is constituted by a front vehicle body 5 and a rear vehicle body 6, which are coupled to each other so as to be swingable relative to each other in the horizontal direction. Right and left front wheels 7 are mounted to the front vehicle body 5, and right and left rear wheels 8 are mounted to the rear vehicle body 6. A pair of right and left steering cylinders 9 is provided between the front vehicle body 5 and the rear vehicle body 6. The traveling direction of the work vehicle 1 is changed in accordance with extension/retraction of the steering cylinders 9. The rear vehicle body 6 includes an operator's cab 10 and an engine room 11. An operator in the operator's cab 10 operates an unshown operating unit to operate the work apparatus 3 and to run the work vehicle 1 (e.g., run the vehicle forward/rearward, accelerate/decelerate the vehicle, and turn the vehicle).

The work apparatus 3 is operably mounted to the vehicle body 2. As one example, the work apparatus 3 includes: a boom 12 coupled to the front vehicle body 5, such that the boom 12 is swingable in the vertical direction; and a bucket 13 coupled to the distal end of the boom 12, such that the bucket 13 is swingable in the vertical direction. The actuator 4 moves the work apparatus 3 in accordance with the supply and discharge of pressure oil to and from the actuator 4. As one example, the actuator 4 includes: a pair of right and left boom cylinders 14 configured to move the boom 12; and a pair of right and left bucket cylinders 15 configured to move the bucket 13.

### Embodiment 1

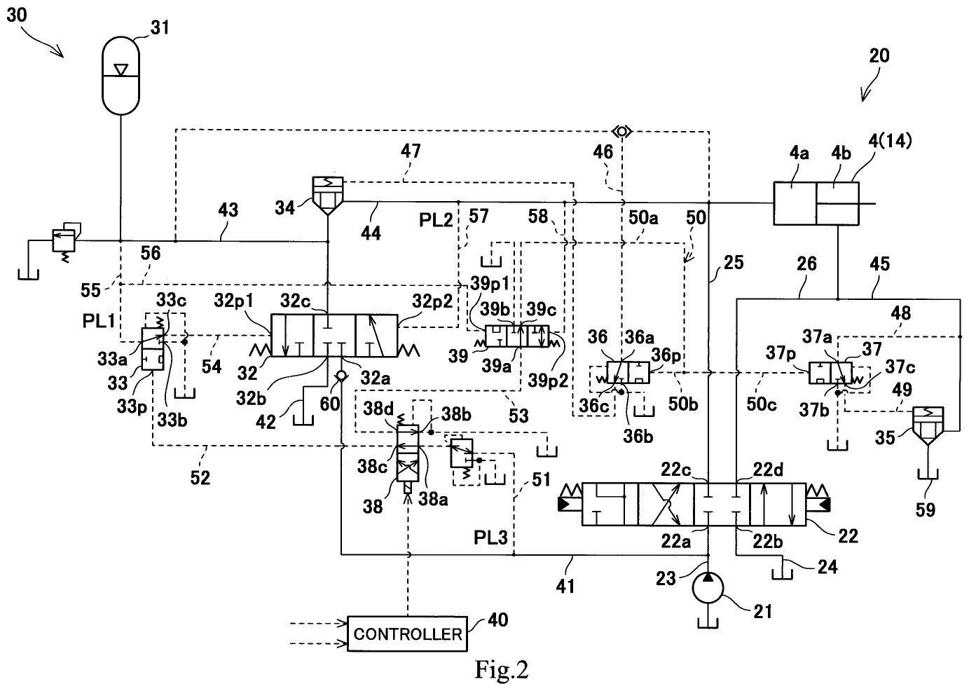

FIG. 2 shows the configuration of a hydraulic system 20 installed in the work vehicle 1 shown in FIG. 1. The hydraulic system 20 includes a pump 21 and a control valve 22. The control valve 22 moves in accordance with the aforementioned operations performed with the operating unit (not shown), thereby controlling the supply and discharge of the hydraulic fluid to and from the actuator 4. In the present embodiment, a boom cylinder 14 is illustratively described as the actuator 4. However, as an alternative, the actuator 4 may be a different type of hydraulic cylinder, or may be a hydraulic motor. As one example, the boom cylinder 14 is a double-acting single-rod cylinder including two pressure chambers that are a head-side fluid chamber 4a and a rod-side fluid chamber 4b .

The control valve 22 includes a pump port 22a, a tank port 22b, and a pair of main supply/discharge ports 22c and 22d. The pump port 22a is connected to the pump 21 via a supply line 23. The tank port 22b is connected to a tank via a discharge line 24. The main supply/discharge port 22c is connected to the head-side fluid chamber 4a via a head supply/discharge line 25. The main supply/discharge port 22d is connected to the rod-side fluid chamber 4b via a rod supply/discharge line 26.

The hydraulic system 20 includes a vibration suppression control circuit 30 (or a vibration suppression control system) according to Embodiment 1. The vibration suppression control circuit 30 includes a pressure accumulator 31, a pressure-regulating valve 32, a signal pressure supply control valve 33, open/close valves 34 and 35, open/close control valves 36 and 37, a mode switching valve 38, an open/close signal pressure supply valve 39, and a check valve 60. The mode switching valve 38 is a solenoid valve controlled by a controller 40.

The controller 40 includes, for example, a processor, a volatile memory, a nonvolatile memory, and an I/O interface. The controller 40 includes a receiving unit, a storage unit, and an output unit. The receiving unit and the output unit are realized by the I/O interface. The storage unit is realized by the volatile memory and the nonvolatile memory. Switching between magnetization and demagnetization of the mode switching valve 38 is realized as a result of the processor of the controller 40 performing arithmetic processing using the volatile memory based on a program stored in the nonvolatile memory.

The pressure-regulating valve 32 includes a pump port 32a, a tank port 32b, a supply/discharge port 32c, a first signal chamber 32p1, and a second signal chamber 32p2. The pressure-regulating valve 32 is a spool type direction switching valve configured to move in accordance with a pressure difference between a first signal pressure PL1 led to the first signal chamber 32p1 and a second signal pressure PL2 led to the second signal chamber 32p2. The pump port 32a is connected to a branch supply line 41, which is branched off from the supply line 23. The check valve 60 is interposed in the branch supply line 41. The tank port 32b is connected to the tank via a discharge line 42. The supply/discharge port 32c is connected to the pressure accumulator 31 via a supply/discharge line 43.

A branch line 44 is branched off from the supply/discharge line 43, and merges with the aforementioned head supply/discharge line 25. The branch line 44 is connected to the head-side fluid chamber 4a via the head supply/discharge line 25. The first open/close valve 34 is provided on the branch line 44. The second open/close valve 35 is provided on a branch discharge line 45, which is branched off from the aforementioned rod supply/discharge line 26 and is connected to the tank 59.

As one example, each of the first open/close valve 34 and the second open/close valve 35 is configured as a poppet. The poppet opens or closes in accordance with the presence or absence of the supply of pressure oil to its poppet upper fluid chamber. The first open/close valve 34 closes as a result of the pressure oil being supplied to its poppet upper fluid chamber. The second open/close valve 35 also closes as a result of the pressure oil being supplied to its poppet upper fluid chamber. However, there is a case where, even while the pressure oil is being supplied to the poppet upper fluid chamber, the pressure upstream of the poppet is higher than the pressure of the poppet upper fluid chamber. In this case, the second open/close valve 35 opens. As a result, cavitation at the cylinder rod side can be prevented. The poppet lower fluid chamber of the first open/close valve 34 is interposed in the branch line 44. The poppet lower fluid chamber of the second open/close valve 35 is interposed in the branch discharge line 45.

The open/close control valves 36 and 37 control the opened/closed state of the open/close valves 34 and 35 in accordance with the presence or absence of the supply of an open/close signal pressure PL3 to the open/close control valves 36 and 37. The first open/close control valve 36 corresponds to the first open/close valve 34, and the second open/close control valve 37 corresponds to the second open/close valve 35.

As one example, each of the first open/close control valve 36 and the second open/close control valve 37 is a pilot type/spring offset type two-position three-port direction switching valve. The first open/close control valve 36 includes an inlet port 36a, a drain port 36b, a supply/discharge port 36c, and a signal chamber 36p. The inlet port 36a is connected to a valve-closing pressure oil line 46, through which pressure oil necessary for closing the first open/close valve 34 flows. As shown in the circuit diagram, the hydraulic fluid whose pressure is a higher one of the pressure of the pressure accumulator 31 and the pressure of the head-side fluid chamber 4a is supplied to the inlet port 36a via the valve-closing pressure oil line 46. The supply/discharge port 36c is connected to the poppet upper fluid chamber of the first open/close valve 34 via a pressure oil supply/discharge line 47.

The second open/close control valve 37 also includes an inlet port 37a , a drain port 37b, a supply/discharge port 37c, and a signal chamber 37p. The inlet port 37ais connected to a valve-closing pressure oil line 48, through which pressure oil necessary for closing the second open/close valve 35 flows. The valve-closing pressure oil line 48 is branched off from the branch discharge line 45 at a position upstream of the second open/close valve 35, and is connected to the inlet port 37a. The supply/discharge port 37c is connected to the poppet upper fluid chamber of the second open/close valve 35 via a pressure oil supply/discharge line 49.

The drain ports 36b and 37b are connected to a drain. The signal chambers 36p and 37p are connected to a signal pressure supply line 50 for supplying the open/close signal pressure PL3. The signal pressure supply line 50 is constituted by: a shared line 50a; a first branch line 50b branched off from the shared line 50a and connected to the signal chamber 36p; and a second branch line 50c branched off from the shared line 50a and connected to the signal chamber 37p.

The mode switching valve 38 includes an inlet port 38a, a drain port 38b, and a pair of supply/discharge ports 38cand 38d. As one example, the mode switching valve 38 is a solenoid type/offset spring type two-position four-port direction switching valve. The signal pressure supply control valve 33 includes an inlet port 33a, a drain port 33b, a supply/discharge port 33c, and a signal chamber 33p. As one example, the signal pressure supply control valve 33 is a pilot type/offset spring type two-position three-port direction switching valve. The open/close signal pressure supply valve 39 includes an inlet port 39a, a drain port 39b, a supply/discharge port 39c, a first signal chamber 39p1, and a second signal chamber 39p2. Similar to the pressure-regulating valve 32, the open/close signal pressure supply valve 39 is also a spool type direction switching valve configured to move in accordance with a pressure difference between the first signal pressure PL1 led to the first signal chamber 39p1 and the second signal pressure PL2 led to the second signal chamber 39p2.

The inlet port 38a of the mode switching valve 38 is connected to a signal pressure line 51, which is branched off from the branch supply line 41. The supply/discharge port 38c is connected to the signal chamber 33p of the signal pressure supply control valve 33 via a signal pressure supply/discharge line 52. The supply/discharge port 38d is connected to the inlet port 39a of the open/close signal pressure supply valve 39 via a signal pressure supply/discharge line 53. The supply/discharge port 39c of the open/close signal pressure supply valve 39 is connected to the shared line 50a of the signal pressure supply line 50.

The first signal chamber 32p1 of the pressure-regulating valve 32 is connected to the supply/discharge port 33c of the signal pressure supply control valve 33 via a supply/discharge line 54. The inlet port 33a of the signal pressure supply control valve 33 is connected to a first signal pressure supply line 55, which is branched off from the supply/discharge line 43. The first signal chamber 39p1 of the open/close signal pressure supply valve 39 is also connected to a first signal pressure supply line 56, which is branched off from the supply/discharge line 43. The second signal chamber 32p2 of the pressure-regulating valve 32 is connected to a second signal pressure supply line 57, which is branched off from the branch line 44. The second signal chamber 39p2 of the open/close signal pressure supply valve 39 is also connected to a second signal pressure supply line 58, which is branched off from the branch line 44. Each of the second signal pressure supply lines 57 and 58 is branched off from the branch line 44 at a position that is closer to the actuator 4 than the first open/close valve 34 is. The pressure of the pressure accumulator 31 is led as the first signal pressure PL1 to both the first signal chamber 32p1 of the pressure-regulating valve 32 and the first signal chamber 39p1 of the open/close signal pressure supply valve 39. However, for the pressure-regulating valve 32, whether or not to allow supplying the first signal pressure PL1 thereto is controlled in accordance with the function of the signal pressure supply control valve 33. The pressure of the head-side fluid chamber 4a is led as the second signal pressure PL2 to both the second signal chamber 32p2 of the pressure-regulating valve 32 and the second signal chamber 39p2 of the open/close signal pressure supply valve 39.

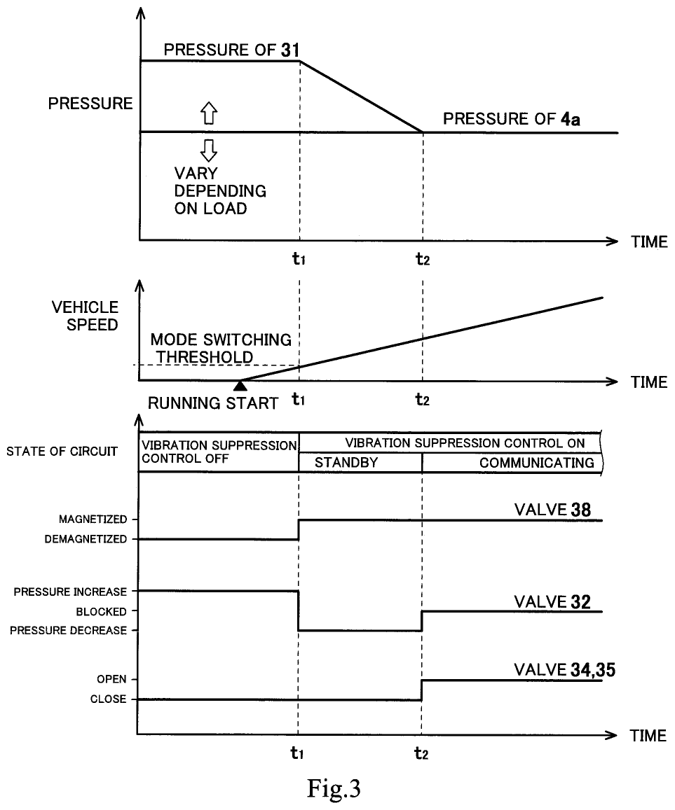

Operations and functions of the vibration suppression control circuit 30 configured as above are described hereinafter with reference to the circuit diagram of FIG. 2 and a timing diagram of FIG. 3.

Based on information indicating the state of the work vehicle 1, which is detected by an in-vehicle sensor, the controller 40 determines whether or not the work vehicle 1 is running. As one example, the controller 40 determines whether or not the vehicle speed (moving speed of the vehicle body) of the work vehicle 1, the vehicle speed being detected by an unshown vehicle speed sensor, is higher than or equal to a mode switching threshold (e.g., 5 to 10 km/h). If the vehicle speed is higher than or equal to the mode switching threshold, the controller 40 determines that the work vehicle 1 is running. Whether or not the work vehicle 1 is running may be determined by using a different determination criterion. It should be noted that while the work vehicle 1 is running normally, the operator does not operate the work apparatus 3. During the time, the control valve 22 is positioned in such a valve position (see the second function from the right in FIG. 2) that the ports 22a to 22d are blocked.

If it is determined that the work vehicle 1 is not running, the controller 40 demagnetizes the mode switching valve 38. As a result, the vibration suppression control circuit 30 is brought into a vibration suppression control OFF state. On the other hand, if it is determined that the work vehicle 1 is running, the controller 40 magnetizes the mode switching valve 38. As a result, the vibration suppression control circuit 30 is brought into a vibration suppression control ON state. Thus, the vibration suppression control circuit 30 is configured to be switchable between the vibration suppression control ON state and the vibration suppression control OFF state while the work vehicle is running.

While the vibration suppression control circuit 30 is in the vibration suppression control OFF state, the mode switching valve 38 is positioned in such a valve position (see the upper function in FIG. 2) that the inlet port 38a is connected to the supply/discharge port 38c and the supply/discharge port 38d is connected to the drain port 38b. Accordingly, the signal pressure PL3 is supplied to the signal chamber 33p of the signal pressure supply control valve 33. As a result, at the signal pressure supply control valve 33, the inlet port 33a is blocked and the supply/discharge port 33c is connected to the drain port 33b (see the lower function in FIG. 2). Consequently, at the pressure-regulating valve 32, the pressure of the second signal chamber 32p2 (i.e., the pressure of the head-side fluid chamber 4a) exceeds the pressure of the first signal chamber 32p1 (i.e., drain pressure). The pressure-regulating valve 32 is positioned in a first position (see the right function in FIG. 2) in which the pump port 32a is connected to the supply/discharge port 32c. Accordingly, the pressure of the pressure accumulator 31 is increased by pressure oil that flows through the supply/discharge line 43. It should be noted that, as described below, the first open/close valve 34 is in a valve-closed state, and the pressure accumulator 31 is blocked from the head-side fluid chamber 4a.

At the open/close signal pressure supply valve 39, the pressure of the first signal chamber 39p1 (i.e., the pressure of the pressure accumulator 31) exceeds the pressure of the second signal chamber 39p2 (i.e., the pressure of the head-side fluid chamber 4a) . The open/close signal pressure supply valve 39 is positioned in a first position (see the left function in FIG. 2) in which the inlet port 39a is blocked and the supply/discharge port 39c is connected to the drain port 39b. Accordingly, both at the first open/close control valve 36 and the second open/close control valve 37, the signal chambers 36p and 37p are connected to the drain. Both the first open/close control valve 36 and the second open/close control valve 37 are positioned in respective valve-closed positions (see the left function in FIG. 2 for the valve 36 and the right function in FIG. 2 for the valve 37) in which the inlet ports 36a and 37a are connected to the supply/discharge ports 36c and 37c, respectively. Both at the first open/close valve 34 and the second open/close valve 35, pressure oil for closing the valve is led to the poppet upper fluid chamber. Accordingly, both the first open/close valve 34 and the second open/close valve 35 are in a valve-closed state. It should be noted that even if the second signal pressure PL2 becomes higher than or equal to the first signal pressure PL1 and the open/close signal pressure supply valve 39 is brought into a position different from the first position, the signal pressure PL3 is not supplied to the inlet port 39a, i.e., not supplied to the open/close control valves 36 and 37. Accordingly, the open/close valves 34 and 35 are kept in a valve-closed state.

When the vibration suppression control circuit 30 switches from the vibration suppression control OFF state to the vibration suppression control ON state (see time tl in FIG. 3), the mode switching valve 38 is magnetized. After the vibration suppression control circuit 30 has switched to the vibration suppression control ON state, the vibration suppression effect is actually exerted only when the head-side fluid chamber 4a has been brought into communication with the pressure accumulator 31. In the description below, a state after the vibration suppression control circuit 30 has switched to the vibration suppression control ON state and before the head-side fluid chamber 4a is brought into communication with the pressure accumulator 31 is referred to as “standby state”, and a state where the head-side fluid chamber 4a is in communication with the pressure accumulator 31 is referred to as “communicating state”.

When the vibration suppression control circuit 30 switches from the vibration suppression control OFF state to the vibration suppression control ON state (standby state), the mode switching valve 38 is brought into such a valve position (see the lower function in FIG. 2) that the inlet port 38a is connected to the supply/discharge port 38d and the supply/discharge port 38c is connected to the drain port 38b. The signal chamber 33p of the signal pressure supply control valve 33 is connected to the drain, and at the signal pressure supply control valve 33, the inlet port 33a is connected to the supply/discharge port 33c (see the upper function in FIG. 2). Accordingly, the pressure of the pressure accumulator 31 is led as the first signal pressure PL1 to the first signal chamber 32p1 of the pressure-regulating valve 32. While the vibration suppression control circuit 30 is in the vibration suppression control OFF state, the pressure of the pressure accumulator 31 is kept high. Accordingly, the first signal pressure PL1 (i.e., the pressure of the pressure accumulator 31) exceeds the second signal pressure PL2 (i.e., the pressure of the head-side fluid chamber 4a). The pressure-regulating valve 32 is brought into a second position (see the left function in FIG. 2) in which the pump port 32a is blocked and the supply/discharge port 32c is connected to the tank port 32b. Accordingly, the pressure accumulator 31 is connected to the tank, and the pressure of the pressure accumulator 31 decreases.

As a result of the mode switching valve 38 switching its valve position, the open/close signal pressure PL3 is supplied to the inlet port 39a of the open/close signal pressure supply valve 39. However, since the first signal pressure PL1 is higher than the second signal pressure PL2, the open/close signal pressure supply valve 39 remains in the aforementioned first position (see the left function in FIG. 2). For this reason, the open/close signal pressure PL3 is not supplied to the signal pressure supply line 50, and the first open/close valve 34 is kept in a valve-closed state continuously from the vibration suppression control OFF state. In this manner, the standby state is realized. Even when the mode switching valve 38 changes its valve position, the open/close signal pressure PL3 is not supplied to the signal chamber 37p. Accordingly, the second open/close control valve 37 is kept in a valve-closed position.

When the pressure of the pressure accumulator 31 has decreased to be equal to the pressure of the head-side fluid chamber 4a, the standby state ends (see time t2 in FIG. 3).

Both at the pressure-regulating valve 32 and at the open/close signal pressure supply valve 39, the first signal pressure PL1 (i.e., the pressure of the pressure accumulator 31) becomes equal to the second signal pressure PL2 (i.e., the pressure of the head-side fluid chamber 4a). The pressure-regulating valve 32 is brought into a third position (see the center function in FIG. 2) in which the pump port 32a and the supply/discharge port 32c are blocked. The open/close signal pressure supply valve 39 is brought into a second position (see the center function in FIG. 2) in which the inlet port 39a is connected to the supply/discharge port 39c. Accordingly, the open/close signal pressure PL3 is led to the signal chamber 36p of the first open/close control valve 36 and the signal chamber 37p of the second open/close control valve 37.

Both the first open/close control valve 36 and the second open/close control valve 37 are brought into respective valve-open positions (see the right function in FIG. 2 for the valve 36 and the left function in FIG. 2 for the valve 37) in which the inlet ports 36a and 37a are blocked and the supply/discharge ports 36c and 37c are connected to the drain ports 36b and 37b, respectively. The poppet upper fluid chamber of each of the first open/close valve 34 and the second open/close valve 35 is connected to the drain, and both the first open/close valve 34 and the second open/close valve 35 are brought into a valve-open state. Accordingly, the head-side fluid chamber 4a is brought into communication with the pressure accumulator 31, i.e., the state shifts from the standby state to the communicating state. In the communicating state, the rod-side fluid chamber 4b is connected to the tank.

In the communicating state, pressure pulsation of the head-side fluid chamber 4a is absorbed by the pressure accumulator 31. As a result, even when external force from a road surface or the like is applied to the work vehicle 1 while it is running, undesirable movement of the actuator 4 can be suppressed. Since vibration of the work apparatus 3 can be suppressed, vibration of the vehicle body 2 and vibration of the operator's cab 10 thereof can be suppressed, accordingly. This makes it possible to improve the comfortableness of the ride while the work vehicle 1 is running.

As described above, in the vibration suppression control circuit according to the present embodiment, when the vibration suppression control circuit switches from the vibration suppression control OFF state to the vibration suppression control ON state, the pressure accumulator 31 is not immediately brought into communication with the head-side fluid chamber 4a, but remains in the state in which the pressure accumulator 31 is blocked from the head-side fluid chamber 4a until the pressure of the pressure accumulator 31 becomes equal to the pressure of the head-side fluid chamber 4a. If the pressure accumulator 31 is brought into communication with the head-side fluid chamber 4a when there is a pressure difference between the pressure of the pressure accumulator 31 and the pressure of the head-side fluid chamber 4a, it is possible that a shock occurs to the vehicle body 2. According to the present embodiment, such a shock can be prevented from occurring, which makes it possible to improve the comfortableness of the ride.

Then, when the pressure of the pressure accumulator 31 has decreased to be equal to the pressure of the head-side fluid chamber 4a (i.e., when a state in which the communication of the pressure accumulator 31 with the head-side fluid chamber 4a does not cause the aforementioned shock is realized), the open/close valves 34 and 35 are opened promptly, and the shift from the standby state to the communicating state is made. Therefore, promptly after the aforementioned state is realized, in which the communication of the pressure accumulator 31 with the head-side fluid chamber 4a does not cause the shock, the vibration suppression control circuit 30 can actually exert the vibration suppression effect, and thereby the comfortableness of the ride can be improved.

The shifting from the standby state to the communicating state utilizes not electromagnetic means but hydraulic pressure, and the vibration suppression control circuit 30 includes necessary components for performing the shifting by means of hydraulic pressure. The state shifting is realized without using such devices as pressure sensors, without requiring the construction of a control routine that refers to results of detection by the pressure sensors, and without requiring the implementation of such a control routine in the controller. This makes it possible to simplify both hardware and software configurations of the vibration suppression control circuit 30.

### Embodiment 2

Hereinafter, a vibration suppression control circuit 130 according to Embodiment 2 is described focusing on its differences from Embodiment 1. In Embodiment 1 described above, the pressure-regulating valve 32 and the open/close signal pressure supply valve 39 are configured as spool type direction switching valves that are independent of each other; and the first signal pressure PL1, which is the pressure of the pressure accumulator 31, and the second signal pressure PL2, which is the pressure of the head-side fluid chamber 4a, are led to each of the valves 32 and 39 for switching their valve position. Similar to Embodiment 1, the vibration suppression control circuit 130 according to the present embodiment is included in a hydraulic system 120 installed in a work vehicle. Meanwhile, the vibration suppression control circuit 130 according to the present embodiment includes an integrated valve 160, which has both the functions of the pressure-regulating valve 32 and the functions of the open/close signal pressure supply valve 39.

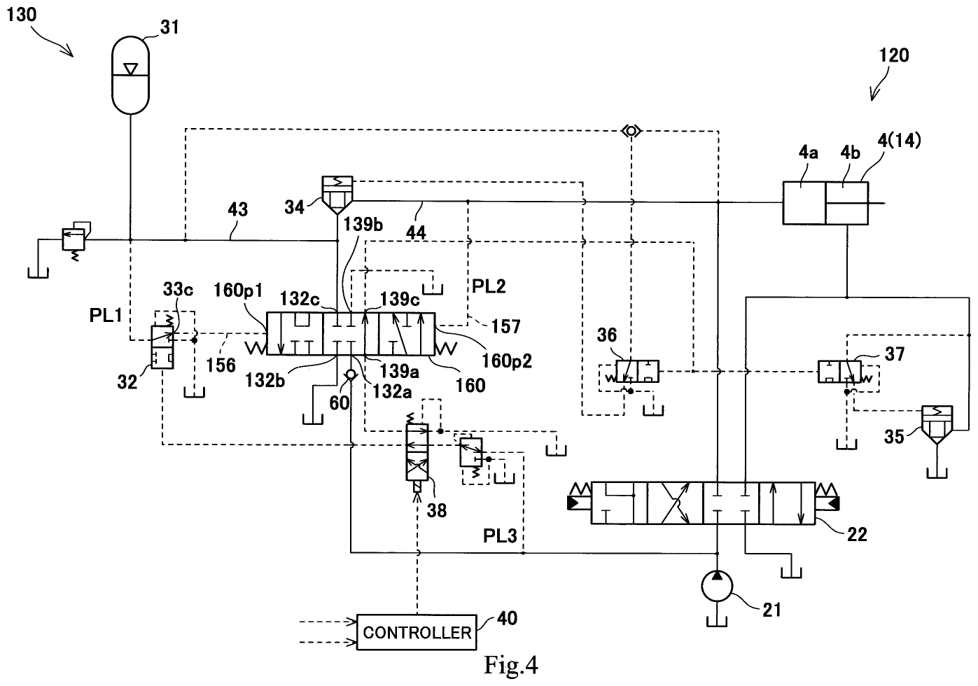

As shown in FIG. 4, the integrated valve 160 is a single-spool pilot type direction switching valve. The integrated valve 160 includes a first signal chamber 160p1 and a second signal chamber 160p2. The first signal chamber 160p1 is connected to the supply/discharge port 33c of the signal pressure supply control valve 33 via a supply/discharge line 156. The second signal chamber 160p2 is connected to a second signal pressure supply line 157, which is branched off from the branch line 44.

The integrated valve 160 includes a pump port 132a, a tank port 132b, a supply/discharge port 132c, an inlet port 139a, a drain port 139b, and a supply/discharge port 139c. The ports 132a to 132c correspond to the ports 32a to 32c of the pressure-regulating valve 32 according to Embodiment 1, and the ports 139a to 139c correspond to the ports 39a to 39c of the open/close signal pressure supply valve 39 according to Embodiment 1.

While the vibration suppression control circuit 130 is in the vibration suppression control OFF state, the second signal pressure PL2 (i.e., the pressure of the head-side fluid chamber 4a) exceeds the first signal pressure PL1 (i.e., drain pressure), and the integrated valve 160 is positioned in a first position (see the right function in FIG. 4) in which the pump port 132a is connected to the supply/discharge port 132c and the supply/discharge port 139c is connected to the inlet port 139a. Accordingly, the pressure is accumulated in the pressure accumulator 31. The supply/discharge port 139c is connected to the drain via the inlet port 139a of the integrated valve 160 and the mode switching valve 38. The open/close signal pressure PL3 is not supplied to the open/close control valves 36 and 37, such that the open/close valves 34 and 35 are in a valve-closed state.

When the vibration suppression control circuit 130 switches from the vibration suppression control OFF state to the vibration suppression control ON state (standby state), the pressure of the pressure accumulator 31 is led as the first signal pressure PL1 to the first signal chamber 160p1 of the integrated valve 160. The first signal pressure PL1 (i.e., the pressure of the pressure accumulator) exceeds the second signal pressure PL2 (i.e., the pressure of the head-side fluid chamber 4a), and the integrated valve 160 is brought into a second position (see the left function in FIG. 4) in which the supply/discharge port 132c is connected to the tank port 132b and the supply/discharge port 139c is connected to the drain port 139b. While the pressure of the pressure accumulator 31 is decreasing, the open/close valves 34 and 35 are kept in a valve-closed state. In this manner, the standby state is realized.

When the pressure of the pressure accumulator 31 has decreased to be equal to the pressure of the head-side fluid chamber 4a, the standby state ends and shifts to the communicating state. That is, the first signal pressure PL1 (i.e., the pressure of the pressure accumulator 31) becomes equal to the second signal pressure PL2 (i.e., the pressure of the head-side fluid chamber 4a), and the integrated valve 160 is brought into a third position (see the center function in FIG. 4) in which the supply/discharge port 132c and the pump port 132a are blocked and the inlet port 139a is connected to the supply/discharge port 139c. The open/close signal pressure PL3 is supplied to the open/close control valves 36 and 37, such that the open/close valves 34 and 35 are brought into a valve-open state. Accordingly, the pressure accumulator 31 is brought into communication with the head-side fluid chamber 4a, and the rod-side fluid chamber 4b is connected to the tank.

The present embodiment provides the same functional advantages as those of Embodiment 1. Further, in the present embodiment, the functions of the pressure-regulating valve 32 and the functions of the open/close signal pressure supply valve 39 are integrated in the integrated valve 160. As a result, the lines for supplying the first signal pressure PL1 and the second signal pressure PL2 are simplified, and the number of valves is reduced. Consequently, the configuration of the vibration suppression control circuit 130 is made compact.

Although the embodiments have been described as above, suitable modifications, deletions, and additions can be made to the above-described configurations within the scope of the present invention.

For example, the signal pressure supply control valve 33 may be a solenoid valve. In this case, the signal chamber 33p of the signal pressure supply control valve 33, and the line that connects one of the ports of the mode switching valve 38 to the signal pressure supply control valve 33, may be eliminated, and the mode switching valve 38 may be used as a valve dedicated to supply and discharge a signal pressure to and from the open/close signal pressure supply valve 39.

### REFERENCE SIGNS LIST

work vehicle

vehicle body

work apparatus

actuator

4a head-side fluid chamber (pressure chamber)

4b rod-side fluid chamber (pressure chamber)

30, 130 vibration suppression control circuit

pressure accumulator

pressure-regulating valve

32a pump port

32b tank port

32c supply/discharge port

32p1 first signal chamber

32p2 second signal chamber

33 signal pressure supply control valve

34, 35 open/close valve

36, 37 open/close control valve

supply/discharge line

branch line

160 integrated valve

PL1 first signal pressure

PL2 second signal pressure

PL3 open/close signal pressure

1. A vibration suppression control circuit installed in a work machine, the work machine including an actuator configured to move a work apparatus mounted to a vehicle body of the work machine in accordance with supply and discharge of pressure oil to and from a pressure chamber of the actuator, the vibration suppression control circuit being switchable between a vibration suppression control OFF state and a vibration suppression control ON state while the work machine is running,
the vibration suppression control circuit comprising:
a pressure accumulator;
a pressure-regulating valve including,
a supply/discharge port connected to the pressure accumulator via a supply/discharge line,
a pump port,
a tank port,
a first signal chamber to which a pressure of the pressure accumulator is led as a first signal pressure, and
a second signal chamber to which a pressure of the pressure chamber is led as a second signal pressure;
a signal pressure supply control valve configured to control whether or not to allow supplying the first signal pressure to the first signal chamber;
an open/close valve provided on a branch line, the branch line being branched off from the supply/discharge line and connected to the pressure chamber; and
an open/close control valve configured to control an opened/closed state of the open/close valve in accordance with presence or absence of supply of an open/close signal pressure to the open/close control valve, wherein
while the vibration suppression control circuit is in the vibration suppression control OFF state,
the signal pressure supply control valve stops supplying the first signal pressure,
the pressure-regulating valve is positioned in a first position in which the supply/discharge port is connected to the pump port, such that the pressure is accumulated in the pressure accumulator, and
the open/close signal pressure is not supplied to the open/close control valve, such that the open/close valve is closed,
when the vibration suppression control circuit switches from the vibration suppression control OFF state to the vibration suppression control ON state,
the signal pressure supply control valve allows supplying the first signal pressure, and
the pressure-regulating valve is brought into a second position in which the supply/discharge port is connected to the tank port, such that the pressure of the pressure accumulator decreases, and
while the vibration suppression control circuit is in the vibration suppression control ON state, when the pressure of the pressure accumulator has become equal to the pressure of the pressure chamber,
the pressure-regulating valve is brought into a third position in which the supply/discharge port is blocked, and
the open/close signal pressure is supplied to the open/close control valve, such that the open/close valve is opened.

2. The vibration suppression control circuit according to claim 1, comprising an open/close signal pressure supply valve including:
a supply/discharge port connected to the open/close control valve;
a first signal chamber to which the pressure of the pressure accumulator is led as a first signal pressure; and
a second signal chamber to which the pressure of the pressure chamber is led as a second signal pressure, wherein
while the vibration suppression control circuit is in the vibration suppression control OFF state, the open/close signal pressure supply valve is positioned in such a valve position that the supply/discharge port is connected to a drain, and
while the vibration suppression control circuit is in the vibration suppression control ON state, when the first signal pressure has become lower than or equal to the second signal pressure, the open/close signal pressure supply valve is brought into such a valve position that the open/close signal pressure is supplied to the supply/discharge port.

3. The vibration suppression control circuit according to claim 1, wherein
the pressure-regulating valve includes an open/close supply/discharge port connected to the open/close control valve,
while the vibration suppression control circuit is in the vibration suppression control OFF state, the pressure-regulating valve is positioned in the first position, such that the open/close supply/discharge port is connected to a drain,
when the vibration suppression control circuit switches from the vibration suppression control OFF state to the vibration suppression control ON state, the pressure-regulating valve is brought into the second position, such that the open/close supply/discharge port is connected to the drain, and
while the vibration suppression control circuit is in the vibration suppression control ON state, when the pressure of the pressure accumulator has become equal to the pressure of the pressure chamber, the pressure-regulating valve is brought into the third position, such that the open/close signal pressure is supplied to the open/close supply/discharge port.
